(19) United States
(12) Patent Application Publication
(10) Pub. No.: US 2004/0176964 A1
(43) Pub. Date: Sep. 9, 2004

(54) Method and system for network-based information handling system issue resolution

(76) Inventors: Junaid Ghaffar, Austin, TX (US); Keith Hester, Austin, TX (US)

Correspondence Address: HAMILTON & TERRILE, LLP, P.O. BOX 203518, AUSTIN, TX, 78720, US

(21) Appl. No.: 10/379,760

(22) Filed: Mar. 5, 2003

(51) Int. Cl. G06F 17/60

(52) U.S. Cl. 705/1; 713/200

(57) ABSTRACT

A method and system are provided which substantially reduce the disadvantages and problems associated with previous methods and systems for resolving issues related to information handling system failures. A self-support application on an information handling system diagnoses failure issues not correctable by self-support and communicates a diagnostic code through a network to a service center. The service center determines the failure issue from the diagnostics code and refers the failure issue to an issue resolution source associated with resolution of the failure issue, such as automated support resolution for failure issues having a known resolution, or phone or electronic message support for failure issues not having a known resolution.

### BACKGROUND OF THE INVENTION

1. Field of the Invention

The present invention relates in general to the field of resolving information handling system issues, and more particularly to a method and system for network-based resolution of information handling system issues.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information processing capabilities of information handling systems have grown dramatically and continue to grow with improved performance of information processing components and more effective system designs and software applications. Often, the increased capabilities of information handling systems results in increased system complexity and that leads to greater user difficulties in resolving issues that arise during use of an information handling system. Difficulties often arise due to failure of hardware components, failure of hardware components to interact correctly, failure or software components and failure of software components to interact correctly with hardware components and/or other software components. When failure issues arise, information handling system users often call the system's manufacturer to obtain help from service technicians to solve the issues. Service technicians attempt to discuss the failure with the user to determine the reason for the failure and resolve the issue.

One difficulty with issue resolution by telephone communication with service technicians is that such resolution is expensive, time-consuming and frustrating for information handling system users. Each call to a service technician is directly expensive for information handling system manufacturers to support in both personnel and equipment and the longer a call takes to complete, the greater the expense. Each call is also indirectly expensive in that users who have extensive difficulty resolving issues with information handling system failures are less satisfied with the manufacturer and thus more likely to purchase elsewhere in the future. One available solution for resolving issues associated with an information handling system failure is to have a user activate and interact with a self-support module that diagnoses and resolves issues without contacting a service technician. However, users having difficulties with an information handling system often ignore self-support options, instead initiating a call to a service center. Once a service technician is on a call with a user, the service technician typically resolves the issue through discussion with the user rather than directing the user to attempt self-support. If the service technician does attempt to have the user initiate self-service, the service technician typically remains on the call with the user and generally increases the length of the call. Often, the issue raised by the user relates to an area outside of the service technician's expertise, resulting in the transfer of the user to other technicians. For instance, service technicians often vary in expertise between hardware and software failures and even specific types of hardware and software components. The extent of the difficulty in issue resolution is unclear since service technicians often fail to enter tracking information for service calls and are prone to inputting incorrect issue resolution codes.

### SUMMARY OF THE INVENTION

Therefore a need has arisen for a method and system which encourages use of self-support applications by users of information handling systems for resolution of failure issues before users contact service technicians.

A further need exists for a method and system which directs service calls to service technicians to aid in reducing the length of the service calls.

A further need exists for a method and system which aids in the logging of information handling system failures and resolution of issues related to failures.

In accordance with the present invention, a method and system are provided which substantially reduce the disadvantages and problems associated with previous methods and systems for resolving issues related to information handling system failures. A self-support application on an information handling system diagnoses failure issues not correctable by self-support and communicates a diagnostic code through a network to a service center. The service center determines the failure issue from the diagnostics code and refers the failure issue to an issue resolution source associated with resolution of the failure issue, such as automated support resolution for failure issues having a known resolution, or phone or electronic message support for failure issues not having a known resolution.

More specifically, a self-support application deployed on plural information handling systems diagnose failure issues relating to hardware and software component failures. The self-support application attempts to resolve failure issues at the information handling system and initiates communication through a network to a support center for failure issues that are not resolvable. The self-support application generates a self-support diagnostics code that uniquely identifies the information handling system and failure issue and displays the diagnostics code for a user to communicate to the service center such as through an electronic message or DTMF inputs made through a telephone. A self-support diagnostics code analyzer at the service center analyzes the diagnostics code to determine the information handling system configuration from the unique identifier and to determine the failure issue. An issue service referral engine applies the information handling system configuration and failure issue to refer the user to an appropriate source for resolution of the issue. For instance, if the failure issue indicates a failure having a known resolution, such as a failure resolved with installation of a new driver or software module, the user is referred to automated support module of automated issue resolution. If the failure issue does not indicate a failure having a known resolution, the type of failure is categorized and forwarded to an appropriate source for resolution, such as phone support or e-mail support from a service technician having expertise in the category of the failure type.

The present invention provides a number of important technical advantages. One example of an important technical advantage is that information handling system users are encouraged to attempt use of self-support applications to resolve system failures before initiating contact with service technicians. For instance, by making a self-support diagnostic code a prerequisite to contacting a service technician, users are encouraged to run the self-support application before contacting a service technician. If the self-support application resolves the issue, a service technician call is avoided resulting in reduced support costs for the information handling system manufacturer and greater satisfaction for the information handling system user.

Another example of an important technical advantage of the present invention is that, by providing the user with a self-support diagnostic code, the service center is able to route service calls more effectively. For instance, the user provides the self-support diagnostics code to the service center which analyzes the type of failure so that the service call is routed to a service technician with expertise in resolving the failure. Routing to service technicians based on the self-support diagnostics code reduces the incidence of transfers of user calls between service technicians thus reducing overall resolution time and making more effective use of service technician resources.

Another example of an important technical advantage is that input by users of self-support diagnostics codes allows precise logging and tracking of information handling system failures that resulted in service calls by users to the service center. Tracking of failures does not depend on judgment calls of service technicians as to the nature of failures or on the inputting of codes by service technicians. Rather, a consistent evaluation of failures is available for the manufacturer of information handling systems to analyze to improve self-support functions as well as the systems themselves to reduce failure occurrences.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a system for network-based information handling system issue resolution; and

FIG. 2 depicts a flow diagram of a process for network-based information handling system issue resolution.

### DETAILED DESCRIPTION

Resolution of failure issues for information handling systems presents a challenge that is expensive and time consuming. The present invention reduces the expense and time for issue resolution by encouraging the use of self-support applications to aid in identifying and more quickly resolving issues for information handling system users. For purposes of this application, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

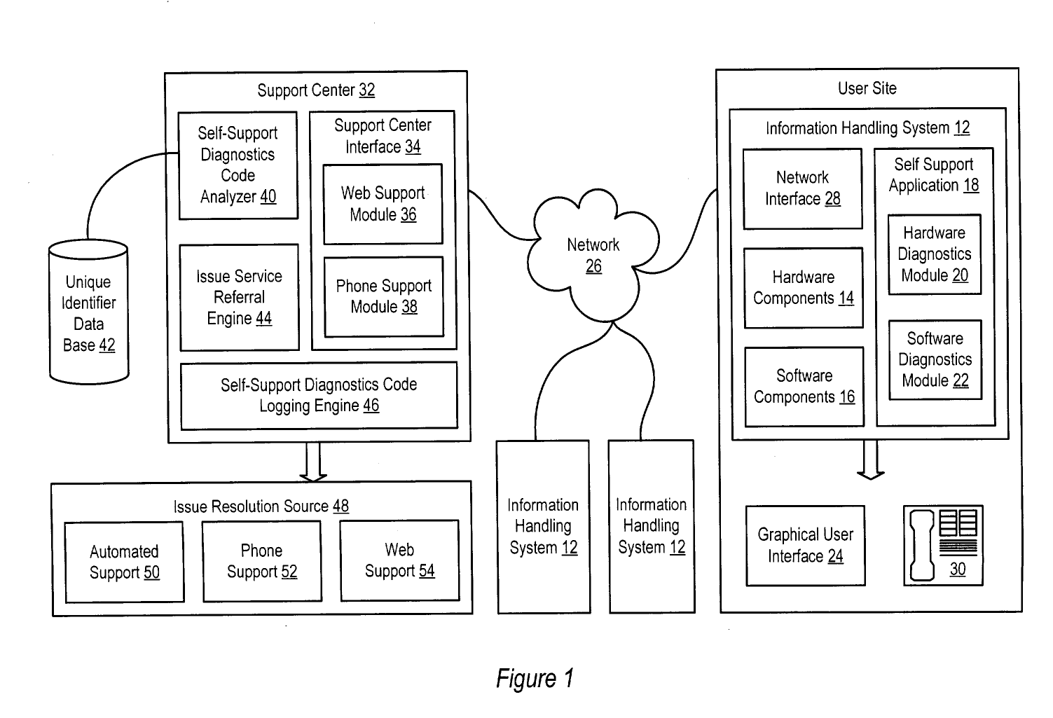

Referring now to FIG. 1, a block diagram depicts a system 10 for network-based issue resolution for information handling systems 12. Information handling system 12 includes hardware components 14, such as the CPU, RAM, BIOS, storage drives, buses and peripherals, and also includes software components which run on the hardware components, such as the operating system and applications that operate in conjunction with the operating system like drivers, controllers, word processing applications, etc. . . . A self-support application 18 loaded on each information handling system monitors the operation of hardware components 14 and software components 16 to detect and, where possible, resolve failure issues that arise. For instance, if a user faces a failure issue, such as a failure of an application to run properly or a hang-up in the information handling system, the user initiates self-support application 18 to attempt to resolve the failure issue. As an example, self-support application 18 displays a graphical user interface 24 that guides a user through steps to identify and, if possible, resolve the failure issue, including running diagnostics on hardware and software components.

In the event that self-support application 18 is unable to resolve a failure issue, a self-support diagnostics code is prepared and displayed at graphical user interface 24. Self-support application 18 generates the diagnostics code based on the inputs of the user during self-support diagnosis, the results output by hardware diagnostics module 20 and software diagnostics module 22, and a unique identifier for the information handling system. For instance, a self-support diagnostics code 1122223333 indicates a failure associated with a component 11 in an information handling system having a unique identifier 2222 and a failure code for component 11 of 3333. In addition to display of the diagnostics code, self-support application 18 determines and displays a support center contact method and point for the user to communicate the diagnostics code through a network 26. As an example, self-support application 18 analyzes a storage drive failure and determines the most effective resolution medium as an electronic message sent to a support center 32 at an address associated with drive failures. The electronic message with the self-support diagnostics code is displayed at graphical user interface 24 and sent through network interface 28 through a network 26, such as the Internet. As another example, self-support application 18 analyzes a modem failure and determines the most effective resolution medium as a telephone message sent to support center 32 using DTMF inputs through a telephone 30 and a network 26, such as the PSTN. An all numerical diagnostics code is displayed on graphical user interface 24 along with a telephone number to call that is associated with resolution of modem failure issues and instructions for the user to contact service center 32 with the phone number to input the diagnostics code with DTMF inputs.

Self-support diagnostics codes sent through network 26 are received at support center 32 through a support center interface 34. Electronic messages, such as e-mails, are received at a Web-support module 36, such as with an XML file attachment that includes the self-support diagnostics code. Telephone contacts are received at a phone support module 38, such as an interactive voice response unit (IVRU) that accepts that the self-support diagnostics code through DTMF inputs. The electronic message address or phone number to which the inquiry is sent is available to aid in directing the inquiry to an appropriate source for resolution. In one embodiment, support center interface 34 requires the input of a self-support diagnostics code before an inquiry is forwarded for resolution. In such an embodiment, a user is provided with a complete failure code to use in the event that the information handling system fails to operate adequately enough to run self-support application 18. The self-support diagnostics code is forwarded to a self-support diagnostics code analyzer 40 which references a unique identifier database 42 to parse the diagnostics code. For instance, the unique identifier is referenced to look up the configuration of the information handling system, including hardware and software components, and determine the component associated with the failure issue.

Self-support diagnostics code analyzer 40 provides the failure issue information determined from the self-support diagnostics code to an issue service referral engine 44 which applies the failure issue information to route the inquiry to an appropriate resolution source. Issue service referral engine 44 forwards each issue inquiry through a self-support diagnostics code logging engine 46 and to issue resolution source 48. Logging engine 46 tracks diagnostics codes by issue failure category type using the configuration information and unique identifier to provide statistical analysis of reported issues. Once issue resolution source 48 resolves an issue, the issue resolution results are returned to logging engine 46 to correlate with reported issues an allow analysis of the effectiveness of issue routing. For instance, if a failure issue inquiry is initially referred to a modem service technician and is then forwarded to an operating system service technician, a heuristic logging engine aids in more efficient future routing of issues having a similar diagnostics code by determining the most efficient initial routing for future issues with that diagnostics code.

In the embodiment depicted in FIG. 1, issue service referral engine 44 routes issue inquiries to an automated support source 50, a phone support source 52 or a Web support source 54. If a self-support diagnostics code for a given component has a know resolution, such as downloading and installing a new driver, automated support 50 performs the known resolution without consuming service technician resources. If a self-support diagnostics code for a given component lacks a known resolution, then issue service referral engine 44 forwards the failure issue inquiry to phone support resource 52 to interface the user with a service technician through telephone communication or to Web support source 54 to interface the user with a service technician through electronic message communication. For instance, failure issues categorized as hardware component failures are routed to service technicians with expertise in hardware and failure issues categorized as software component failures are routed to service technicians with expertise in software. In one embodiment, failure issues associated with component failures supported by third parties, such as the component's manufacturer, are routed to the third party for resolution.

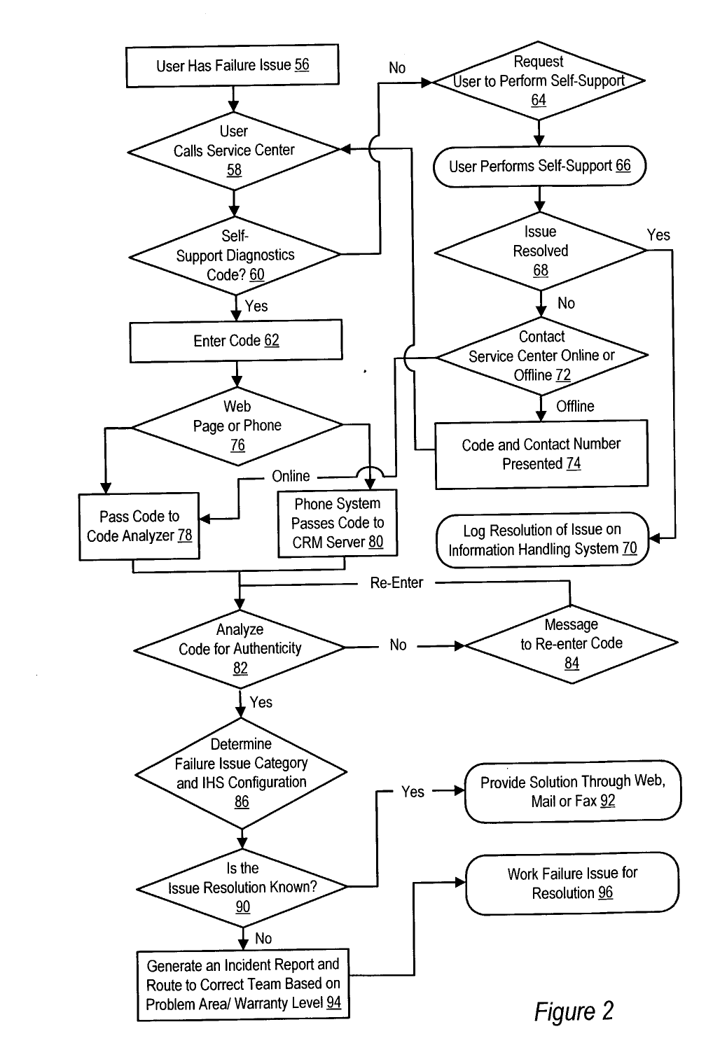

Referring now to FIG. 2, a flow diagram depicts a process for network-based issue resolution for information handling systems. The process begins at step 56 with a failure issue of an information handling system user, meaning some incorrect operation or performance of the information handling system user. At step 56, the user places a phone call to a service center in an attempt to resolve the failure issue. At step 60, the user is requested to provide a self-support diagnostics code which, if available, is entered at step 62. If the user does not have a diagnostics code at step 60, the process proceeds to step 64 at which the user is requested to run the self-support application. At step 66, the user either runs the self-support application or obtains a complete failure code and, at step 68 a determination is made of whether the failure issue is resolved. If the failure issue is resolved, the process ends at step 70 with a logging of the resolution at the information handling system. If the failure issue remains unresolved with the running of the self-support application at the information handling system, the process continues to step 72 for a determination of whether to contact the service center online or offline. If the determination is offline, the process returns to step 58 and if the determination is online, the process proceeds directly step 78 for inputting of the diagnostics code.

At step 76, a determination is made at the service center of whether an inquiry is made to the service center by phone or by electronic message. If by electronic message, the process continues to step 78 to accept the diagnostics code electronically and if by phone, the process continues to step 80 to accept the diagnostics code with DTMF inputs. At step 82, the service center analyzes the diagnostics code to determine its authenticity, such as by looking up the unique identifier and comparing the diagnostics code with possible results. If the code is not authentic, the process allows re-entry attempts at step 84. If the code is authentic, then at step 86 the failure issue is determined by category and the information handling system configuration is identified. At step 90, a determination is made of whether the resolution of the issue is known. If so, the process ends at step 92 with the resolution. If the resolution to the problem is not known, the process continues to step 94 for generation of an incident report based on Information Handling System unique identifier and routing of the issue to an appropriate resolution source. The process ends at step 96 with the failure issue worked to resolution.

Although the present invention has been described in detail, it should be understood that various changes, substitutions and alterations can be made hereto without departing from the spirit and scope of the invention as defined by the appended claims.

What is claimed is:

1. A system for information handling system issue resolution, the system comprising:
a self-support application deployed to plural information handling systems, each self-support application operable to diagnose one or more information handling system failure issues and to output a diagnostic code that identifies the failure issue and provides instructions for contacting a support center through a network;
a support center interface operable to accept the self-support diagnostics code from a user inquiry communicated through the network;
a self-support diagnostics code analyzer interfaced with the support center interface and operable to validate the self-support code and associate the self-support code with an issue; and
an issue service referral engine operable to refer the user inquiry to an issue resolution source associated with the self-support code and issue.

2. The system of claim 1 wherein the issue comprises an issue having a known self-support resolution, the issue service referral engine further operable to refer the user inquiry to an automated support module for performing the known resolution.

3. The system of claim 2 wherein the known self-support resolution comprises a software update and the automated support module is operable to download the software update to the information handling system and to inform the user of the resolution of the issue by the software download.

4. The system of claim 2 wherein the known self-support resolution comprises a firmware update and the automated support module is operable to download the firmware update to the information handling system and to inform the user of the resolution of the issue by the firmware download.

5. The system of claim 1 wherein the issue comprises an issue lacking a self-support resolution, the issue service referral engine further operable to categorize the issue by type and to refer the user inquiry to a phone support module having a service technician associated with resolution of the self-support diagnostics code issue category type.

6. The system of claim 5 wherein the category types comprise types categorized by hardware and software component types.

7. The system of claim 1 wherein the issue comprises an issue lacking a self-support resolution, the issue service referral engine further operable to categorize the issue by type and to refer the user inquiry to a Web support module having a service technician associated with resolution of the self-support diagnostics code issue category type.

8. The system of claim 1 wherein the self-diagnoses code further comprises a unique identifier associated with the information handling system, the self-support diagnostics code analyzer operable to apply the unique identifier to a unique identifier database to identify software and hardware components of the information handling system.

9. The system of claim 1 further comprising a self-support diagnostics code logging engine operable to log and track self-support diagnostics code issues and resolutions.

10. A method for network based information handling system resolution, the method comprising:
performing self-support diagnosis on an information handling system to diagnosis a failure issue associated with the information handling system;
determining that self-support at the information handling system is unable to resolve the issue;
generating a self-support diagnostics code at the information handling system, the self-support diagnostics code associated with the diagnosed failure issue;
communicating the self-support diagnostics code to a support center;
analyzing the self-support diagnostics code at the support center to determine the issue;
categorizing the issue by failure type; and
referring the issue to a resolution source associated with the categorized failure type.

11. The method of claim 10 wherein:
generating a self-support diagnostics code further comprises generating a service telephone number to call for resolution of the issue; and
communicating the self-support diagnostics code further comprises calling the service telephone number to input the self-support diagnostics code over a telephone network.

12. The method of claim 11 wherein generating a service telephone number further comprises:
categorizing the issue by failure type; and
selecting one of plural telephone numbers to display at the information handling system, the selection of the telephone number based on the categorized failure type.

13. The method of claim 10 wherein:
generating a self-support diagnostics code further comprises generating an electronic message address to contact for resolution of the issue; and
communicating the self-support diagnostics code further comprises sending an electronic message to the generated address to input the self-support diagnostics code.

14. The method of claim 13 further comprising:
categorizing the issue by failure type; and
selecting one of plural electronic message addresses at the information handling system to send the self-support diagnostics code, the selection of the electronic message address based on the categorized failure type.

15. The method of claim 10 wherein communicating the self-diagnosis code to the service center further comprises requiring the self-diagnosis code in order to establish communication with the service center.

16. The method of claim 15 further comprising providing a complete failure self-diagnostics code at the information handling system to allow the establishing of communication with to the service center in the event of an inability by the information handling system to perform self-diagnostics.

17. The method of claim 10 wherein categorizing the issue by failure type further comprises categorizing the issue as having a know resolution, and wherein referring the issue to a resolution source further comprises referring the issue for automated support to resolve the known issue.

18. An information handling system comprising:
hardware components operable to run software components that process information;
software components operable to run on the hardware components; and
a self-support diagnostics module interfaced with the hardware and software components, the self-support diagnostics module operable to diagnose failure issues associated with the information handling system, to categorize the failure issue by type and to coordinate communication through a network with a service center, the communication directed to within the support center based on the categorized failure type.

19. The information handling system of claim 18 wherein the categorized failure types comprise a hardware failure type and a software failure type.

20. The information handling system of claim 18 wherein the self-support diagnostics module is further operable to coordinate communication by displaying a self-support diagnostics code that identifies the failure type and uniquely identifies the information handling system.
